(19) United States
(12) Patent Application Publication
(10) Pub. No.: US 2007/0161372 A1
(43) Pub. Date: Jul. 12, 2007

(54) Cordless phone system with integrated alarm & remote monitoring capability

(76) Inventors: Gary Rogalski, Richmond (CA); Ralph Tischler, Richmond (CA); Guy Pothiboon, Richmond (CA)

Correspondence Address: PAUL, HASTINGS, JANOFSKY & WALKER LLP, P.O. BOX 919092, SAN DIEGO, CA, 92191-9092, US

(21) Appl. No.: 11/648,905

(22) Filed: Jan. 3, 2007

Related U.S. Application Data
(60) Provisional application No. 60/755,848, filed on Jan. 4, 2006.

(51) Int. Cl. H04Q 7/20

(52) U.S. Cl. 455/426.1

(57) ABSTRACT

A cordless telephone system provides home security. Each handset associated with the cordless telephone system detects a noise level. If the detected noise level exceeds a threshold level, the handset detecting the noise level exceeding the threshold level initiates a telephone call through the base unit to an alert telephone number. When the telephone call to the alert telephone number is established, a message is played to provide notification of a possible home security breach, such as an intruder.

The present invention claims the benefit of U.S. Provisional Appln. No. 60/755,848, filed Jan. 4, 2006, which is hereby incorporated by reference herein in its entirety.

### BACKGROUND

1. Field of the Invention

Embodiments of the present invention relate generally to the field of telephone communications. More particularly, the present invention relates to integrating a home security system in a cordless telephone.

2. Background of the Invention

Home security is a necessary part of modern society. Locks, burglar alarms and the like are designed to keep out intruders who might steal contents of a home or harm its occupants. Whether home or away, a home security system provides comfort to home owners who know that the system will likely warn them and/or authorities of the presence of an intruder.

Unfortunately, modern day home security systems are generally expensive, and difficult to install. For example, windows must be taped and doors must be configured such that they provide notice to the home security system when they are opened. Further, these systems include many mechanical parts, including detectors, that are susceptible to failure and wear. Motion detectors and other devices can provide auditory warnings to a dwelling's occupants. However, unless they are connected to a more expensive monitoring system, they do not provide warnings to home owners or authorities. The expense, in particular, can place home security systems beyond the reach of many home owners. Consequently, a more affordable home security system is required.

### BRIEF SUMMARY OF THE INVENTION

Embodiments of the present invention provide a system and method for affordable home security by integrating a home security system into a cordless telephone system. Cordless telephone systems include one or more handsets. The handsets have digital signal processing (DSP) capability, such as voice level detection. Embodiments of the present invention use the DSP capability to detect a noise signal. For example, in one embodiment of the present invention, voice level detection processing is used to detect a noise level. The detection can be periodic or at other pre-established times. The detected noise level is compared to a threshold noise level. If the detected noise level exceeds the threshold noise level, the handset initiates a telephone call to an alert telephone number. The telephone call is initiated through the base unit of the cordless telephone system. When the telephone call is established to the alert telephone number, a message is played. The message indicates that there may be a security breach, such as an intruder. In addition, location of the handset detecting a noise level exceeding the threshold noise level may be provided in the message.

In one embodiment, the present invention is a cordless telephone system for providing home security. The cordless telephone system includes a base unit having a base unit memory for storing an alert telephone number to call if a noise level above a threshold noise level is detected. The cordless telephone system additionally includes one or more handsets associated with the base unit, each handset having a digital signal processor for detecting a noise level and a memory for storing a threshold noise level. In operation, the one or more handsets detect a noise level and compare it to the threshold level, and cause a message to be played to the alert telephone number.

In another embodiment, the present invention is a method for providing home security using a cordless telephone system. The method begins with detecting a noise level using a handset of a cordless telephone system. The detected noise level is compared to a threshold noise level. If the detected noise level exceeds the threshold noise level, a telephone call to an alert telephone number is initialized.

### BRIEF DESCRIPTION OF THE DRAWINGS

FIG. 1 is a schematic diagram of a cordless telephone system 100 according to an embodiment of the present invention.

FIG. 2 is a block diagram of apparatus in a handset for home security applications according to an embodiment of the present invention.

FIG. 3 is a flow chart for a method for integrating home security into a cordless telephone system according to an embodiment of the present invention.

FIG. 4 is a flow chart for a method for calibrating a cordless telephone having integrated security features according to an embodiment of the present invention.

FIG. 5 is a flow chart for a method for configuring a cordless telephone having integrated security features according to an embodiment of the present invention.

### DETAILED DESCRIPTION OF THE INVENTION

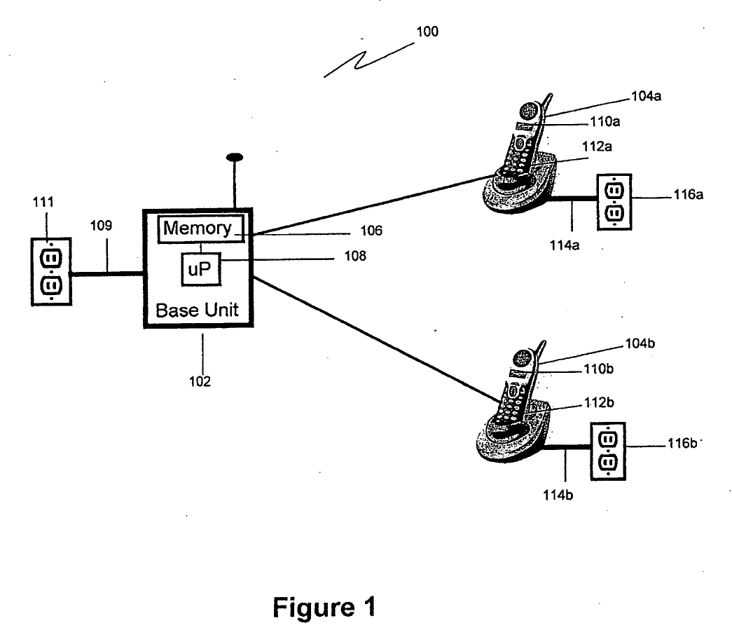

FIG. 1 is a schematic diagram of a cordless telephone system 100 according to an embodiment of the present invention. Cordless telephone system 100 includes a base unit 102 and one or more handsets 104a and 104b. Base unit 102 includes a microprocessor 108 or other electronic control circuitry for controlling the functionality of base unit 102. For example, those skilled in the art would understand that the functionality performed by microprocessor 108 performed herein could be performed by any electronic control circuitry for carrying out the functions of microprocessor 108 described herein. Such electronic circuitry, for example, includes microcontrollers, electronic sequencers, field programmable gate arrays (FPGAs) and other electronic circuitry.

Base unit 108 also includes a memory for storing data required for the operation of base unit 102. Base unit 102 may also include a screen for displaying information about telephone calls or stored messages, such as number of stored messages. Base unit 102 may also include one or more cradles for storing one or more handsets, such as handsets 104a and 104b. Each cradle provides power to its handset as well as charges its handset. The cradles are also referred to as chargers. A power cord 109 plugs into a wall socket 111 to provide power to base unit 102

Handsets 104a and 104b are generally stored in cradles 105a and 105b respectively. Cradles 105a and 105b provide power to handsets 104a and 104b respectively, as well as provide for charging the handsets. Cradles 105a and 105b are also referred to as chargers. A power cord 114a plugs into a wall socket 116a to provide power to cradle 105a. A power cord 114b plugs into a wall socket 116b to provide power to cradle 105b.

Handsets 104a and 104b include respective display screens 110a and 110b, and respective keypads 112a and 112b. Display screens 110a and 110b are used to display information about incoming calls such as the telephone number and caller name. Display screen 110a and 110b can also display other information such as date and time, as well as other digital and video data. For example, display screens 1l0a and 110b are used to provide the man-machine interface (“MMI”) for configuring cordless telephone system 100.

Handsets 104a and 104b can also include a microprocessor or other electronic control circuitry and memory for data storage. The microprocessor or other electronic control circuitry works in conjunction with the memory to provide home security capability as described herein.

Embodiments of the present invention enhance conventional cordless telephone systems by integrating home security functionality into the cordless telephone system. According to an embodiment of the present invention, handsets 104a and 104b are configured to detect a security breach, such as an intruder, by detecting noise above a noise threshold. When noise above the noise threshold is detected in one embodiment of the present invention, the handset initiates a telephone call to the home owner through base unit 102. When the telephone call is established, base unit 102 provides a notification message providing notification of the possible security breach.

Because base unit 102 receives handset identification information, it knows which handset is responding to the noise detection. In an embodiment of the present invention, the base unit is configured with location information corresponding to where handsets 104a and 104b are located. The location information can be stored, for example, in a base unit memory 106, along with the corresponding handset identification, such that the location information can be retrieved using the handset identification. For example, handset 104a may be in one bedroom, and handset 104b may be in a second bedroom. Additional handsets may be used for other rooms.

As a result, when the base unit makes the telephone call to the home owner, the base unit can identify the handset detecting noise above the threshold and then obtain location information corresponding to the identified handset. The base unit can then incorporate the obtained location information in the notification message.

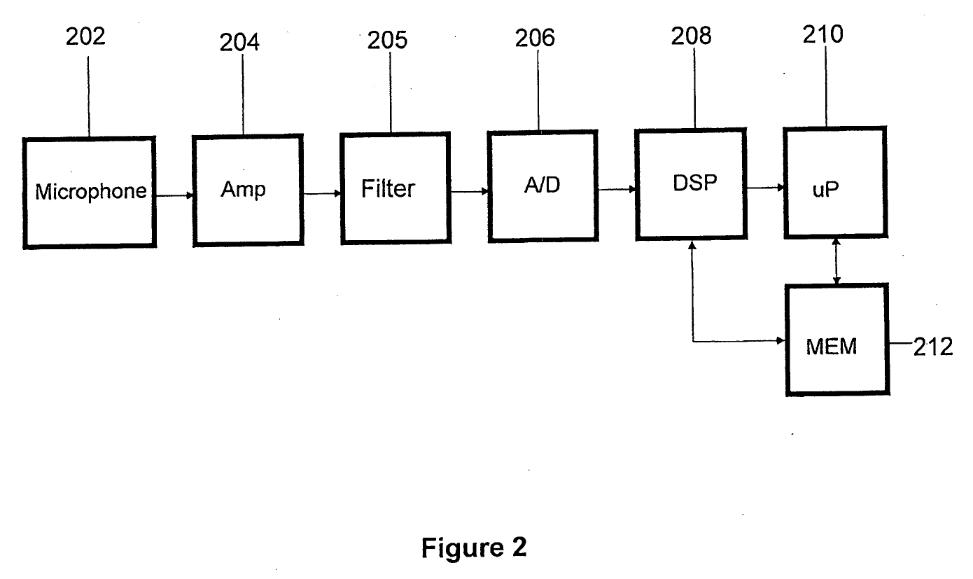

FIG. 2 is a schematic diagram of apparatus in a handset such as handset 104a or 104b for home security applications according to an embodiment of the present invention.

In operation, the handset is set for home security operation is placed in the Home Security mode of operation using the MMI on the handset. For example, a soft button labeled “Home Security” may be selected by the home owner. Selection of the Home Security soft button causes the handset to be placed in the Home Security mode of operation.

In the Home Security mode of operation, the handset listens to noise detected as a noise signal detected through a microphone 202. The detected noise signal is conditioned. For example, the detected noise signal can be conditioned by an amplifier 204 and filter 205. The detected noise signal is digitized through an analog-to-digital converter 206 to generate a digitized noise signal.

Detection of the noise signal can be periodic or at other pre-established time. For example, detection of a noise signal could be programmed to take place every second or every minute. Alternatively, noise level detection could be pre-programmed to occur more frequently at night than during the day.

A digital signal processor (DSP) 208 in the handset performs certain processing of the digitized noise signal. For example, DSP 208 filters the digitized noise signal to smooth it prior to comparing it to a threshold. After filtering the signal, DSP 208 performs determines a signal level associated with the digitized noise signal. Determination of the signal level can be performed using conventional speech level detectors available in cordless telephone systems. The signal level is used by microprocessor 210 in threshold detection. A memory 212 is provided that can be used by DSP 208 or microprocessor 210 during operation. Memory 212 can also be used for storing the threshold noise level.

It would be known to those skilled in the art that the functionality performed by microprocessor 210 performed herein could be performed by any electronic control circuitry for carrying out the functions of microprocessor 210 described herein. Such electronic circuitry, for example, includes microcontrollers, electronic sequencers, field programmable gate arrays (FPGAs) and other electronic circuitry.

A number of threshold detection techniques that can be employed would be known to those skilled in the art. For example, microprocessor 210 can compare the digitized noise level to a threshold level. The threshold level can be pre-determined. However, a pre-determined threshold may not take into account the specifics of a particular home in which an embodiment of the present invention is implemented.

In another embodiment of the present invention, each handset in the cordless system can have a unique threshold level. The base unit can also have a threshold level, and monitor noise levels as described above, for the area in which the base unit is located.

One way for adapting the threshold level to a particular environment according to an embodiment of the present invention is for the home owner to adjust the threshold level using the MMI. For example, the MMI may provide a soft button for increasing sensitivity (by decreasing the threshold) or decreasing sensitivity (by increasing the threshold). Decreased sensitivity might be appropriate for a home with animals that might create a noisier environment than one without animals.

A technique for adapting the threshold level to a particular environment according to another embodiment of the present invention is to determine the threshold level in a set up mode. In the set up mode, for example, the threshold level is calibrated for handset 100 by determining a noise level when there is no security breach. For example, this can be accomplished by allowing handset 100 to record an ambient noise level during a Security Calibration mode of operation. In one embodiment of the present invention, the Security Calibration mode of operation is selected by selecting a soft button in the MMI labeled “Security Calibration”. The noise level so determined is stored for later comparison with the digitized noise level when the cordless telephone system is set to operate in the Home Security mode of operation.

When the cordless telephone system is set to operate in the Home Security mode of operation, microprocessor 210 compares the digitized noise level with the stored threshold level. Microprocessor 210 determines what action to take based upon whether the digitized noise exceeds the threshold level. If the digitized noise does not exceed the threshold level, microprocessor 210 takes no additional action. If, on the other hand, the digitized noise exceeds the threshold level, microprocessor 210 can take a number of actions.

In one embodiment of the present invention, when the threshold level is exceeded, microprocessor 210 initiates a telephone call through base unit 102 to an alert telephone number. Such a alert telephone number can be provided by the home owner. The alert phone number is stored in base unit memory 106. For example, the phone number can be stored in a configuration phase to use an embodiment of the present invention. Upon making a connection to the alert telephone number, either base unit 102 or the handset that sensed the threshold level being exceeded plays a notification message to the user. The notification message can be any informational message. For example, the notification message may tell the home owner that there is a possible security breach, such as an intruder.

In addition, the notification message may identify the particular location where the intruder may be. In one embodiment of the present invention, location identification is provided by determining which handset detected the threshold level being exceeded. This can be done in base unit 102 by detecting handset identification information the handset sends to base unit 102. During a Security Configuration mode of operation, a location corresponding to each handset 104a and 104b is stored in base unit memory 106. For example, one handset may have as its corresponding location stored in the base unit memory, the bedroom. Another handset may have as its corresponding location stored in the base unit memory, the living room. When a handset (e.g., handset 104a or 104b) initiates a telephone call to the alert number, base unit 102 accesses memory 106 to find the location associated with the handset, and adds the associated location to the notification message.

The messages can be stored in a memory in the handset or in base unit memory 106. Using well known voice synthesis techniques, the message can be played to the home owner after the call is established to the alert telephone number.

In another embodiment of the present invention, the handset sensing that the threshold has been exceeded, plays a message through its speaker. The message can be any message. For example, the message can be, “This property is protected by an alarm system.” Such a message can also be generated by the base unit through its speakerphone.

In an alternate embodiment of the present invention, multiple threshold levels are determined, for example at different times of the day. These thresholds are stored and used for comparison purposes as described above. More complex threshold detection can be used as would be known to those skilled in the art.

An additional feature of the present invention is provided by the memory in either the base unit or the handset. That is using the microphone of the handset, any audio information detected by the microphone can be saved to the memory. In an alternative embodiment of the present invention, audio detected by the handset is transmitted to the base unit for storage in a memory associated with the base unit.

The apparatus of FIG. 2 can also be implemented in base unit 102. In this manner, base unit 102 can also detect a security breach, and initiate a notification to the alert telephone number.

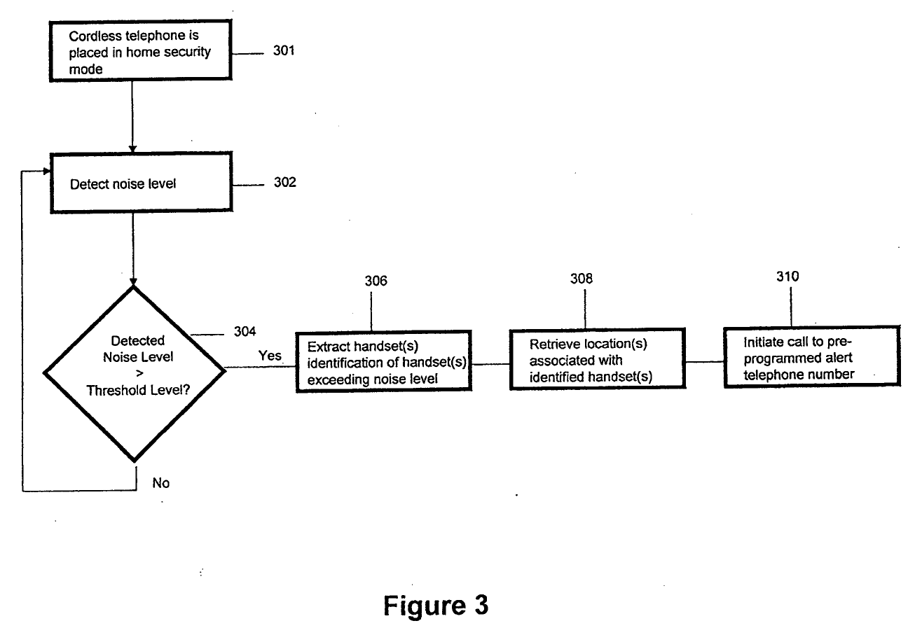

FIG. 3 is a flow chart for a method for integrating home security into a cordless telephone system according to an embodiment of the present invention. In step 302, the noise level is detected. For example, the noise level is detected using the a cordless telephone handset. In step 304, the detected noise level is compared to a threshold level. If the noise level does not exceed the threshold level, the method continues in step 302 where the noise level is again detected. If, on the other hand, the detected noise level, exceeds the threshold level, the method continues in step 306 where identification of the handset that detected the noise level in excess of the threshold is determined. In step 308, the location of the handset that detected the noise level in excess of the threshold is determined based on the handset identification determined in step 306. Then, in step 310, a telephone call is initiated to a alert telephone number, for example, provided by the home owner, to send a notification message of the security breach. In one embodiment of the present invention, the telephone call is initiated through the base unit of the cordless telephone system by the handset detecting the noise level exceeding the threshold level.

In an alternate embodiment of the present invention, the notification message does not include the location of a security breach. In such an embodiment, steps 306 and 308 are not required. As a result, after the method determines that the threshold has been exceeded in step 304, the method in such an embodiment continues in step 310 where a call is initiated to the alert telephone number to provide notification of the security breach.

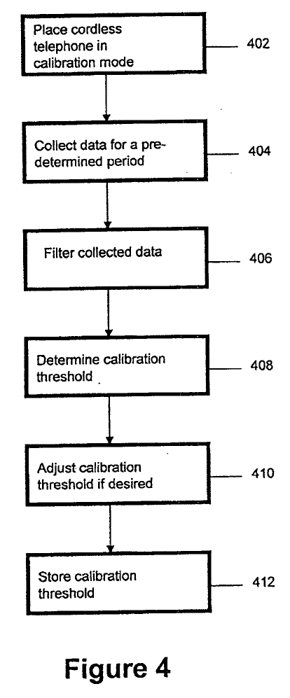

FIG. 4 is a flow chart for a method for calibrating a cordless telephone having integrated security features according to an embodiment of the present invention. In step 402, a user places the cordless telephone in a Security Calibration Mode of operation on handset 104a or 104b or base unit 102, depending on which unit is being calibrated at the time. In one embodiment of the present invention, the user does this by selecting a “Security Calibration” soft button on the MMI. Once in the Calibration Mode of operation, in step 404, the unit (handset 104a or 104b or base unit 102) collects data for a predetermined period of time.

In step 406, the data is filtered, for example, using filter 205. Prior to filtering, the date may be amplified if desired. In step 408, a calibration threshold is determined. The calibration threshold can be the average value of the collected filtered noise. In another embodiment, the threshold may be chosen as a noise value that is a chosen number of standard deviations away from the average noise value.

Any desired function can be used to determine the noise threshold based on the collected noise. In step 410, the threshold is adjusted if desired as described above, for example, to suit the particular environment in which the cordless telephone security features are to be used. After any adjustment of the calibration threshold in step 410, or after determining the calibration threshold in step 408 where no adjustment is desired, the calibration threshold is stored in step 412.

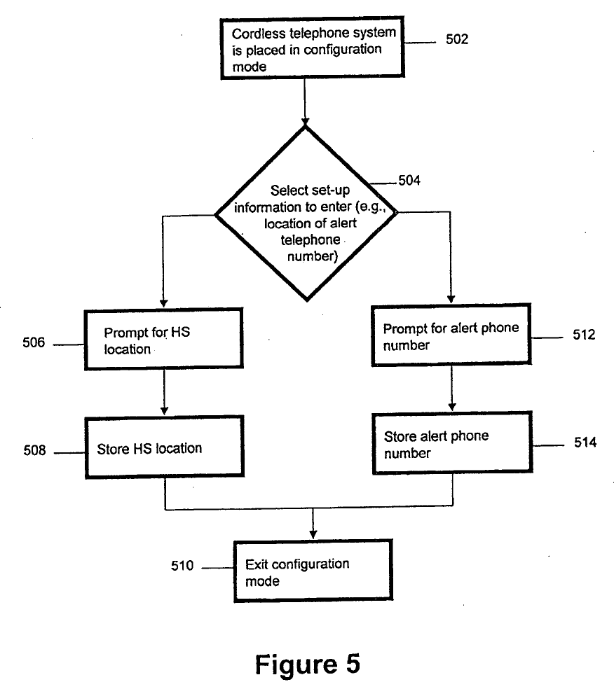

FIG. 5 is a flow chart for a method for configuring a cordless telephone having integrated security features according to an embodiment of the present invention. In step 502, the cordless telephone system is placed in a Configuration Mode of operation. In one embodiment of the present invention, the user does this by selecting a “Configuration Mode” soft button on the MMI. Once in the Configuration Mode of operation, in step 504, the desired configuration information to be input is selected. In the embodiment shown in FIG. 5, the user can select to enter the location of a handset or the alert telephone number to which the notification is sent. If the user selects to enter a handset location, the method continues in step 506 where the user is prompted to enter the handset location. The user then enters the handset location, for example, by typing the location for a particular handset using the keypad of base unit 102. The handset location is stored in step 508. The Configuration Mode of operation is then exited in step 510.

If the user chooses the provide an alert telephone number to be called in the event of a security breach in step 504, the method continues in step 512 where the user if prompted to enter the alert telephone number. The user enters the alert telephone number using a keypad on base unit 102. The alert telephone number is stored in step 514. The method is then exited in step 510.

Although an embodiment of the present invention for home security purposes has been described in terms of a home and a home owner, the present invention can be used in any environment in which a cordless telephone system can be used. For example, an embodiment of the present invention can be used in an office building to provide a less expensive alternative for office protection.

In addition, a miniature camera can be incorporated into the handset and/or base unit. When a security breach is detected (i.e., the detected noise level exceeds the threshold level), the camera is turned on to store video imagery of the room in which the security breach occurred. In an alternate embodiment, the camera may be configured to record one or more photographs of the room in which the security breach occurred.

Additional monitors could be added to the handsets and/or base unit of the cordless telephone system to provide indications of adverse or dangerous conditions in a home. For example, a carbon monoxide (CO) monitor or moisture monitor could be added to one or more of the handsets and/or the base unit. If a CO level detected by the CO monitor exceeded a CO threshold level, a telephone call would be initiated to the alert telephone number to advise the home owner of a possible dangerous condition in the home. Similarly, if a moisture level detected by the moisture monitor exceeded a moisture threshold, a call would be initiated to the alert telephone number to advise the home owner of a possible moisture problem in the home.

In another embodiment of the present invention, a motion detector can be added to one or more of the handsets and/or the base unit of the cordless telephone system. In the Home Security mode of operation, if a motion detector detects motion (indicative of a security breach), a message is sent to the alert telephone number. In addition, a message can be played through the speaker of the handset and/or a speaker on the base unit to announce the property is protected by a security system.

The foregoing disclosure of the preferred embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto, and by their equivalents.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

What is claimed is:

1. A cordless telephone system for providing home security, comprising:
a base unit having a base unit memory for storing an alert telephone number; and
one or more handsets associated with the base unit, each handset having a digital signal processor for detecting a noise level, and a memory for storing a threshold noise level;
wherein during a home security mode of operation of the cordless telephone system, each of the one or more handsets detects a noise level, compares the detected noise level to the threshold noise level, and causes a call to be initiated to an alert telephone number and a notification message to be played if the detected noise level exceeds the threshold noise level.

2. The cordless telephone system of claim 1 wherein one or more notification messages are stored in the base unit.

3. The cordless telephone system of claim 1, wherein a location associated with each of the one or more handsets is stored in the base unit memory, and wherein the location of a handset having a detected noise level that exceeds the threshold level is including the message place to the alert telephone number.

4. The cordless telephone system of claim 1, further comprising a motion detector in one or more of the handsets and base unit.

5. The cordless telephone system of claim 1, further comprising a carbon monoxide detector in one or more of the handsets and base unit.

6. The cordless telephone system of claim 1, further comprising a moisture detector in one or more of the handsets and base unit.

7. The cordless telephone system of claim 1, further comprising camera to record video or one or more snapshots of a room in which a handset or base unit detects a threshold noise level exceeded.

8. The cordless telephone system of claim 1, further comprising a speaker through which a notification message is played.

9. The cordless telephone system of claim 8, wherein the speaker is in a handset.

10. The cordless telephone system of claim 8, wherein the speaker is in the base unit.

11. The cordless telephone system of claim 1, wherein audio information is stored to the base unit memory when the threshold noise level is exceeded.

12. The cordless telephone system of claim 1, wherein there is a plurality of threshold noise levels, each threshold noise level corresponding to a different time of day.

13. The cordless telephone system of claim 1, further comprising a calibration mode of operation for calibrating the threshold noise level.

14. The cordless telephone system of claim 1, further comprising a configuration file.

15. The cordless telephone system of claim 15, wherein the configuration file includes the alert telephone number.

16. The cordless telephone system of claim 15, wherein the configuration file includes a location of each handset.

17. A method for providing home security using a cordless telephone system, comprising:
detecting a noise level using a handset of a cordless telephone system.
comparing the detected noise level to a threshold noise level; and
initializing a telephone call to an alert telephone number if the detected noise level exceeds the threshold noise level.

18. The method of claim 17, further comprising determining the threshold noise level by calibration.

19. The method of claim 17, further comprising determining a plurality of threshold noise levels, each threshold noise level corresponding to a different time of day.

20. The method of claim 17, further comprising storing a location corresponding to at least one handset of the cordless telephone system in a configuration file.

21. The method of claim 20, further comprising determining a location corresponding to where the threshold noise level was exceeded.

22. The method of claim 21, further comprising playing a message through a speaker at the determined location.

23. The method of claim 21, further comprising storing video of the determined location.

24. The method of claim 21, further comprising storing at least one photograph of the determined location.

25. The method of claim 17, further comprising monitoring adverse or dangerous conditions.

26. The method of claim 25, wherein the condition is related to moisture.

27. The method of claim 25, wherein the condition is related to carbon monoxide.

28. The method of claim 25, wherein the condition is detection of motion.
